(19) United States
(12) Patent Application Publication
(10) Pub. No.: US 2020/0373860 A1
(43) Pub. Date: Nov. 26, 2020

(54) AUTOMATIC DEVICE AND COMMUNICATION SYSTEM

(71) Applicant: NIDEC CORPORATION, Kyoto (JP)

(72) Inventor: Jun NISHIYAMA, Kyoto (JP)

(21) Appl. No.: 16/767,119

(22) PCT Filed: Oct. 22, 2018
(86) PCT No.: PCT/JP2018/039142

§ 371 Date: May 27, 2020

(30) Foreign Application Priority Data
Dec. 5, 2017 (JP) 2017-233087

(51) Int. Cl. H02P 5/50; G08C 17/00; B60K 1/02

(52) U.S. Cl. CPC H02P 5/50; B60K 1/02; G08C 17/00

(57) ABSTRACT

An automatic device includes: a support; a first motor attached to the support; a second motor attached to the support; a first motor drive unit configured to drive the first motor; a second motor drive unit configured to drive the second motor; a first control unit configured to control the first motor drive unit; and a second control unit configured to control the second motor drive unit. The first control unit includes a first wireless communication circuit configured to wirelessly communicate with the external control device. The first control unit and the second control unit are communicably wired with each other.

### CROSS-REFERENCE TO RELATED APPLICATIONS

This is the U.S. national stage of application No. PCT/JP2018/039142, filed on Oct. 22, 2018, and priority under 35 U.S.C. § 119(a) and 35 U.S.C. § 365(b) is claimed from Japanese Application No. 2017-233087, filed on Dec. 5, 2017.

### FIELD OF THE INVENTION

The present disclosure relates to an automatic device and a communication system.

### BACKGROUND

Conventionally, a technique of giving instruction information from a control terminal to a plurality of motor modules provided in one robot by wireless communication has been known.

In wireless communication, however, not all motor modules can receive instruction information due to a propagation loss. In addition, a plurality of motor modules may receive instruction information at different timings depending on the propagation path or the wireless communication system. Therefore, operations of a plurality of motor modules may fail to synchronize.

### SUMMARY

An automatic device according to one exemplary aspect of the present disclosure includes: a support; a first motor attached to the support; a second motor attached to the support; a first motor drive unit configured to drive the first motor; a second motor drive unit configured to drive the second motor; a first control unit configured to control the first motor drive unit; and a second control unit configured to control the second motor drive unit, in which the first control unit includes a first wireless communication circuit for wireless communication with an external control device, and in which the first control unit and the second control unit are communicably wired with each other.

A communication system according to another exemplary aspect of the present disclosure includes: the above automatic device; and the external control device.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view showing a moving body that is an automatic device according to an embodiment of the present disclosure;

FIG. 2 is a front view of a rotating base unit of the moving body according to the embodiment;

FIG. 3 is a side view of a moving device according to the embodiment of the present disclosure;

FIG. 4 is a perspective view of the moving device according to the embodiment;

FIG. 5 is a block diagram of a control system including the moving body according to the embodiment;

FIG. 6 is a sequence diagram showing an example of operation of controlling a plurality of motors in the control system according to the embodiment;

FIG. 7 is a diagram showing an example of a control command transmitted from an external computer of the control system according to the embodiment;

FIG. 8 is a sequence diagram showing another example of operation of controlling the plurality of motors in the control system according to the embodiment;

FIG. 9 is a sequence diagram showing an example of operation of measuring and reporting each condition in the control system according to the embodiment;

FIG. 10 is a diagram showing an example of a measurement command transmitted from the external computer of the control system according to the embodiment;

FIG. 11 is a diagram showing an example of a condition report transmitted inside the moving body according to the embodiment;

FIG. 12 is a diagram showing an example of a condition report transmitted from the moving body of the control system to the external computer according to the embodiment; and

FIG. 13 is a sequence diagram showing another example of operation of measuring and reporting each condition in the control system according to the embodiment.

### DETAILED DESCRIPTION

Embodiments of the present disclosure will be described below with reference to the accompanying drawings.

FIG. 1 is a perspective view showing an automatic device according to an embodiment of the present disclosure. In the present embodiment, the automatic device is a moving body 1. The moving body 1 includes a vehicle body (chassis, support) 2 and two wheels 4A, 4B supported by the vehicle body 2 in a rotatable manner. The vehicle body 2 is a substantially horizontal frame provided at a lower portion of the moving body 1. The wheels 4A, 4B are of the same shape and size, and are arranged concentrically.

The vehicle body 2 includes two wheel motors 6A, 6B for respectively driving the wheels 4A, 4B mounted thereon. The vehicle body 2 also includes a battery case 8 mounted thereon that accommodates a battery that is a power supply for driving the wheel motors 6A, 6B. Further, the vehicle body 2 is equipped with printed boards 10A, 10B, 12A, 12B on which circuits for driving the wheel motors 6A, 6B are arranged. The printed boards 12A, 12B are connected to each other with a cable 13 for wired communication described later.

Further, the vehicle body 2 is equipped with a plurality of columns 14, and the columns 14 support a rotating base unit 16. The rotating base unit 16 includes a support base 18 and a rotating base 20 having the same diameter. The support base 18 is fixed to the upper ends of the columns 14. The rotating base 20 is disposed above the support base 18 and concentrically with the support base 18.

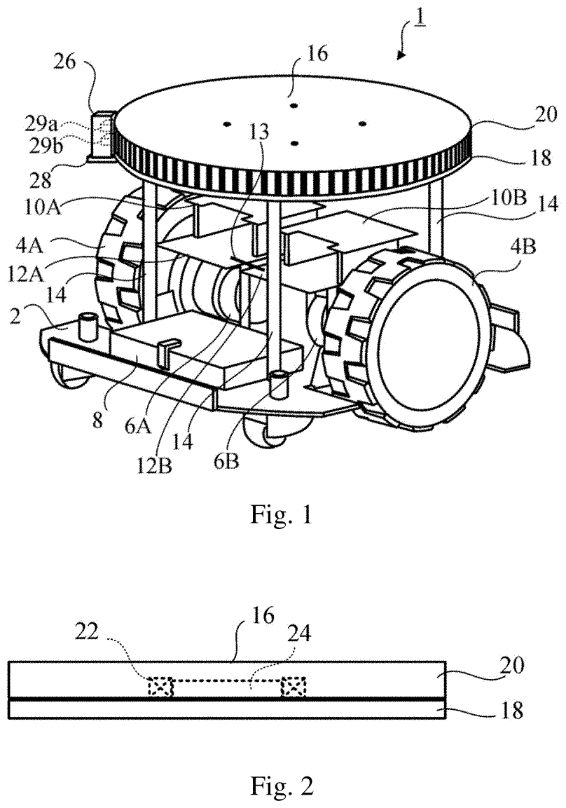

As shown in FIG. 2, the support base 18 is equipped with a bearing 22, and in the bearing 22, a rotating-base-metal-fitting 24 that is attached to the rotating base 20 is inserted. The bearing 22 may be attached to the rotating base 20, and the rotating-base-metal-fitting 24 may be attached to the support base 18 and inserted in the bearing 22. In either case, the rotating base 20 is rotatable with respect to the support base 18 about a substantially vertical axis.

The moving body 1 is provided with a measuring device for measuring the rotation angle of the rotating base 20 of the rotating base unit 16. The measuring device is not limited, but may be a photo sensor 26, for example. Specifically, the support base 18 is equipped with a bracket 28, and the bracket 28 supports the photo sensor 26, as shown in FIG. 1. The photo sensor 26 has two photo reflectors 29a, 29b, for example.

The outer circumferential surface of the rotating base 20 has a plurality of white portions and a plurality of black portions that are provided in an alternate manner. The plurality of white portions are arranged at equal angular intervals, and the plurality of black portions are also arranged at equal angular intervals. The white portions and the black portions may be provided by coloring, or may be provided by attaching pieces of white tape and black tape to the rotating base 20.

Each of the photo reflectors 29a, 29b has a light-emitting element (e.g., a light-emitting diode) and a light-receiving element (e.g., a phototransistor), and the light-receiving element receives the light that has been emitted from the light-emitting element and reflected on the outer circumferential surface of the rotating base 20. The light-receiving element outputs an electric signal corresponding to the intensity of the received light. The level of the electric signal output from the light-receiving element varies depending on whether the light-receiving element faces the white portion or the black portion. Therefore, the rotation angle of the rotating base 20 can be measured by grasping the number of times the level of the electric signal has changed since the rotating base 20 has been positioned at a reference angle.

In the present embodiment, the two photo reflectors 29a, 29b have different angular positions with respect to the rotating base 20. Since the different angular positions cause a difference in the output phases of the two photo reflectors 29a, 29b, which makes it possible to determine the rotation direction of the rotating base 20.

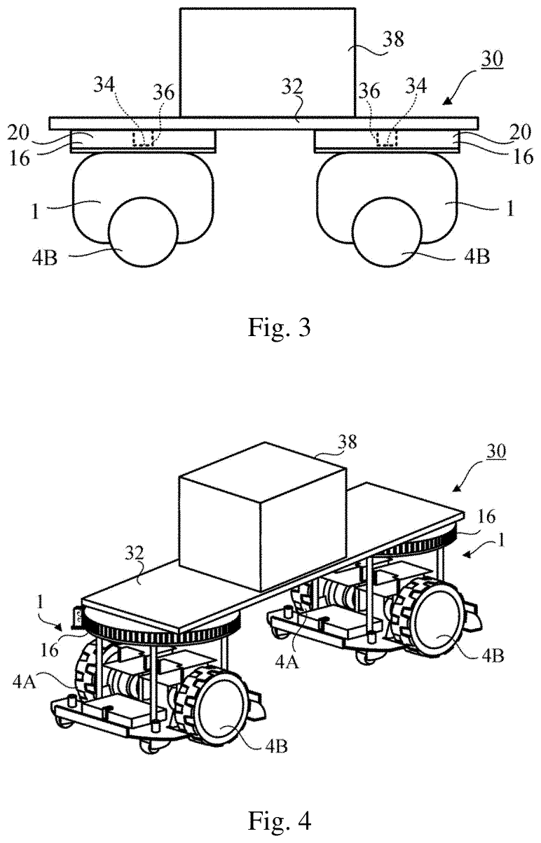

FIGS. 3 and 4 show a moving device 30 according to the embodiment. The moving device 30 includes a connecting carrier 32 that joins the rotating bases 20 of the rotating base units 16 of the two moving bodies 1.

Specifically, a groove or a recess 34 is formed at the center of each rotating base 20, and two protrusions 36 are formed or attached to the lower surface of the connecting carrier 32. Each of the protrusions 36 is fitted into the recess 34. The connecting carrier 32 does not rotate with respect to the rotating base 20 of each of the moving bodies 1.

The connecting carrier 32 has a flat upper surface, and can carry a load 38 on the upper surface.

The moving body 1 alone can also carry the load 38. In this case, the load 38 is placed on the rotating base 20 of the rotating base unit 16 without using the connecting carrier 32.

However, the moving device 30 formed by joining a plurality of moving bodies 1 with the connecting carrier 32 can carry a heavy load 38. In this case, the rotating bases 20 of the rotating base units 16 of the plurality of moving bodies 1 connected by the connecting carrier 32 rotate according to the respective travelling directions of the moving bodies 1, which does not hamper travelling of the moving bodies 1.

In the moving device 30 shown in the figures, two moving bodies 1 are joined together, but three or more moving bodies 1 may be joined together by connecting the rotating bases 20 of their rotating base units 16 with one another.

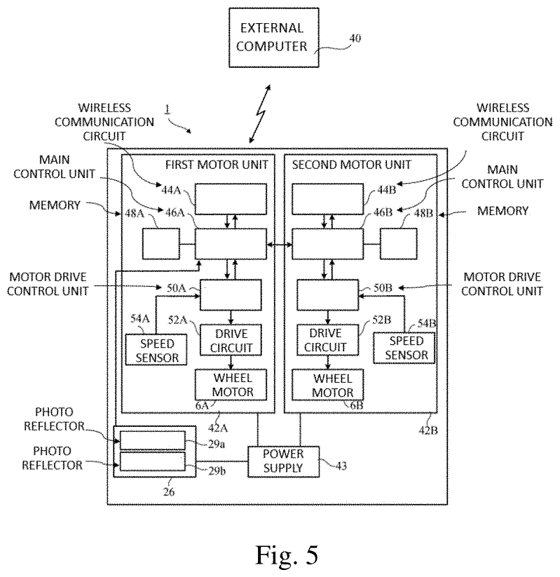

FIG. 5 is a block diagram of a control system including the moving body 1 according to the embodiment of the present disclosure. The moving body 1 can communicate with an external computer (external control device) 40 configured to remotely operate the moving body 1 by wireless communication. Therefore, the control system shown in FIG. 5 can be considered as a communication system. The wireless communication method is not limited, but Wi-Fi (registered trademark) may be employed, for example.

The moving body 1 includes two motor units, that is, a first motor unit 42A and a second motor unit 42B. The motor units 42A, 42B respectively correspond to the wheel motors 6A, 6B.

The motor units 42A, 42B are powered by a power supply 43. The power supply 43 is a battery accommodated in the battery case 8 (see FIG. 1). The photo sensor 26 is also powered by the power supply 43.

The first motor unit 42A includes the wheel motor 6A, a wireless communication circuit 44A, a main control unit 46A, a memory 48A, a motor drive control unit 50A, a drive circuit 52A, and a speed sensor 54A. The second motor unit 42B includes the wheel motor 6B, a wireless communication circuit 44B, a main control unit 46B, a memory 48B, a motor drive control unit 50B, a drive circuit 52B, and a speed sensor 54B. Hereinafter, the wheel motor 6A may be referred to as a first wheel motor 6A, and the wheel motor 6B may be referred to as a second wheel motor 6B.

The wireless communication circuit 44A, the main control unit 46A, the memory 48A, and the motor drive control unit 50A are mounted on the printed board 12A (see FIG. 1) as a main control circuit. The drive circuit 52A includes an inverter and a motor driver, and is mounted on the printed board 10A (see FIG. 1). The wireless communication circuit 44B, the main control unit 46B, the memory 48B, and the motor drive control unit 50B are mounted on the printed board 12B (see FIG. 1) as a main control circuit. The drive circuit 52B includes an inverter and a motor driver, and is mounted on the printed board 10B (see FIG. 1).

The wireless communication circuits 44A, 44B are configured to wirelessly communicate with the external computer 40. However, in the present embodiment, only the wireless communication circuit 44A of the first motor unit 42A is normally used. The wireless communication circuit 44B of the second motor unit 42B can be used as a backup in case of a failure of the wireless communication circuit 44A. Alternatively, the wireless communication circuit 44B of the second motor unit 42B can be used as an auxiliary circuit. For example, the wireless communication circuit 44A can be used for reception from the external computer 40, and the wireless communication circuit 44B can be used for transmission to the external computer 40.

Each of the main control units 46A, 46B is a processor, and operates by reading and implementing a program stored in a recording medium (not shown). Therefore, the program (program code) itself read from the recording medium implements the function of the embodiment. Further, the recording medium storing the program can constitute the present disclosure.

The main control unit 46A wirelessly communicates with the external computer 40 using the wireless communication circuit 44A. The main control unit 46A controls the motor drive control unit 50A to control driving of the wheel motor 6A. Further, the main control unit 46A is communicably wired to the main control unit 46B of the second motor unit 42B.

The main control unit 46B controls the motor drive control unit 50B to control driving of the wheel motor 6B. Further, the main control unit 46B can wirelessly communicate with the external computer 40 using the wireless communication circuit 44B as necessary.

The memories 48A, 48B are configured to store data necessary for the respective main control units 46A, 46B to perform processing. The main control units 46A, 46B are configured to read necessary data from the respective memories 48A, 48B. The memories 48A, 48B are volatile memories, but may be nonvolatile memories. Further, each of the memories 48A, 48B may include both a volatile memory and a nonvolatile memory.

The motor drive control unit 50A is configured to control driving (for example, the rotational speed) of the wheel motor 6A according to a command from the main control unit 46A. The motor drive control unit 50B is configured to control driving (for example, the rotational speed) of the wheel motor 6B according to a command from the main control unit 46B. Each of the motor drive control units 50A, 50B, for example, can perform proportional-integral-differential (PID) control or vector control, for example, and is formed of a microprocessor, an application specific integrated circuit (ASIC), or a digital signal processor (DSP), for example.

The drive circuit 52A is configured to drive the wheel motor 6A under the control of the motor drive control unit 50A. The drive circuit 52B is configured to drive the wheel motor 6B under the control of the motor drive control unit 50B.

The speed sensors 54A, 54B are configured to output electric signals indicating the rotational speeds of the wheel motors 6A, 6B, respectively. The speed sensors 54A, 54B are, for example, Hall sensors that are mounted inside the wheel motors 6A, 6B, respectively, and are configured to convert a magnetic field into an electric signal. The motor drive control unit 50A determines the rotational speed of the wheel motor 6A based on the output signal of the speed sensor 54A. That is, the motor drive control unit 50A measures the rotational speed of the wheel motor 6A. The motor drive control unit 50B determines the rotational speed of the wheel motor 6B based on the output signal of the speed sensor 54B. That is, the motor drive control unit 50B measures the rotational speed of the wheel motor 6B. The measured value of the rotational speed of the wheel motor 6A is notified to the main control unit 46A, and the main control unit 46A uses the value of the rotational speed of the wheel motor 6A to provide a command for controlling driving of the wheel motor 6A to the motor drive control unit 50A. The measured value of the rotational speed of the wheel motor 6B is notified to the main control unit 46B and the main control unit 46B uses the value of the rotational speed of the wheel motor 6B to provide a command for controlling driving of the wheel motor 6B to the motor drive control unit 50B.

Further, the motor drive control unit 50A calculates the torque of the wheel motor 6A with a publicly known calculation method based on the current value of the drive circuit 52A. That is, the motor drive control unit 50A measures the torque of the wheel motor 6A. The motor drive control unit 50B calculates the torque of the wheel motor 6B with a publicly known calculation method based on the current value of the drive circuit 52B. That is, the motor drive control unit 50B measures the torque of the wheel motor 6B. The measured value of the torque of the wheel motor 6A is notified to the main control unit 46A, and the main control unit 46A uses the value of the torque of the wheel motor 6A to provide a command for controlling driving of the wheel motor 6A to the motor drive control unit 50A. The measured value of the torque of the wheel motor 6B is notified to the main control unit 46B, and the main control unit 46B uses the value of the torque of the wheel motor 6B to provide a command for controlling driving of the wheel motor 6B to the motor drive control unit 50B.

The output signals of the two photo reflectors 29a, 29b of the photo sensor 26 are supplied to the main control unit 46A of the first motor unit 42A. According to the above configuration, the main control unit 46A determines the rotation direction of the rotating base 20 and also the rotation angle of the rotating base 20 based on the output signals of the photo reflectors 29a, 29b. That is, the main control unit 46A measures the rotation angle of the rotating base 20.

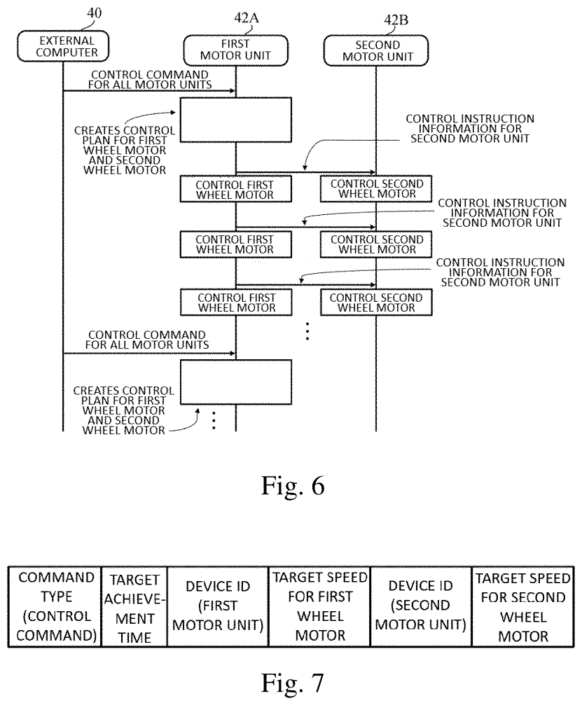

With reference to FIGS. 6 and 7, the description will be given of an example of operation of controlling the wheel motors 6A, 6B of the motor units 42A, 42B performed based on a control command from the external computer 40. This operation is individually performed for each moving body 1 in the moving device 30 including a plurality of moving bodies 1 (see FIGS. 3 and 4).

As shown in FIG. 6, the external computer 40 transmits a control command for all the motor units 42A, 42B to the first motor unit 42A by wireless communication. The control command for all the motor units 42A, 42B is a control command for controlling driving of both the wheel motors 6A, 6B.

As shown in FIG. 7, a format of the control command includes, for example, a field indicating a command type, a field indicating a target achievement time, and a field indicating a first device ID (a device ID for the first motor unit 42A), a field indicating a target speed for the first wheel motor 6A, a field indicating a second device ID (a device ID for the second motor unit 42B), and a field indicating a target speed for the second wheel motor 6B. The field indicating a command type includes a bit string indicating that the transmitted command is a control command for setting a target speed. The field indicating a target achievement time includes a bit string indicating a time period until the wheel motors 6A, 6B reach a target speed after the control command is received. The field indicating a device ID includes a bit string indicating an ID for the motor unit having the wheel motor to be controlled by the control command. That is, the two fields indicating the device IDs each include a bit string indicating the device ID for the first motor unit 42A or a bit string indicating the device ID for the second motor unit 42B. The field indicating a target speed immediately after the field indicating the device ID of the first motor unit 42A includes a bit string indicating a target speed for the first wheel motor 6A. The field indicating a target speed immediately after the field indicating the device ID of the second motor unit 42B includes a bit string indicating a target speed for the second wheel motor 6B.

It is assumed that, for example, this control command specifies 100 ms as the target achievement time, 100 rpm as the target speed for the first wheel motor 6A, and 200 rpm as the target speed for the second wheel motor 6B. In this case, according to the control command, the first motor unit 42A should adjust the rotational speed of the wheel motor 6A to reach 100 rpm, and the second motor unit 42B should adjust the rotational speed of the wheel motor 6B to reach 200 rpm in 100 ms after the control command is received.

Referring back to FIG. 6, in the first motor unit 42A, the main control unit 46A creates a control plan for the first wheel motor 6A and the second wheel motor 6B when the wireless communication circuit 44A receives the control command. Specifically, the main control unit 46A determines instantaneous target speeds for the first wheel motor 6A and the second wheel motor 6B for each moment until the target achievement time has elapsed. Each of the moments is separated from one another by a constant control cycle.

The determination may be made by interpolation based on the current rotational speed of each motor, the target speed for each motor specified in the control command, and the target achievement time specified in the control command. For example, in the case where the wheel motors 6A, 6B are stopped (in the case where the rotational speeds are 0 rpm) when the control command of the above assumed example is received, the main control unit 46A determines the instantaneous target speed for the first wheel motor 6A for each moment of every 1 ms so as to increase the rotational speed of the first wheel motor 6A by 1 rpm for each moment of every 1 ms. Further, the main control unit 46A determines the instantaneous target speed for the second wheel motor 6B for each moment of every 1 ms so as to increase the rotational speed of the second wheel motor 6B by 2 rpm for each moment of every 1 ms. Thus, after a lapse of 100 ms, the rotational speed of the wheel motor 6A reaches 100 rpm, and the rotational speed of the wheel motor 6B reaches 200 rpm. In this example, the main control unit 46A uses linear interpolation in determining the instantaneous target speeds for the wheel motors 6A, 6B, but may use another interpolation algorithm.

When the wireless communication circuit 44A receives the control command, the main control unit 46A stores the received control command in the memory 48A before creating a control plan, and then creates a control plan using the control command read from the memory 48A.

Once determining the instantaneous target speeds for the wheel motors 6A, 6B as described above, the main control unit 46A stores the instantaneous target speeds for the wheel motors 6A, 6B in the memory 48A.

Thereafter, the main control unit 46A controls the motor drive control unit 50A to adjust the rotational speed of the first wheel motor 6A according to the control plan. That is, the main control unit 46A reads the instantaneous target speed for the first wheel motor 6A from the memory 48A at each moment, and repeats, in a constant control cycle (for example, every 1 ms), controlling of the motor drive control unit 50A so that the rotational speed of the first wheel motor 6A reaches the instantaneous target speed. Further, the main control unit 46A transmits control instruction information on control of driving of the second wheel motor 6B to the second motor unit 42B by wired communication according to the control plan. That is, the main control unit 46A reads the instantaneous target speed of the second wheel motor 6B from the memory 48A at each moment, and repeats, in a constant control cycle (for example, every 1 ms), transmitting of the control instruction information indicating the instantaneous target speed of the second wheel motor 6B to the second motor unit 42B by wired communication.

In the second motor unit 42B, the main control unit 46B repeatedly receives the control instruction information indicating the instantaneous target speed for the second wheel motor 6B from the first motor unit 42A in a constant control cycle (for example, every 1 ms). Every time the main control unit 46B receives the control instruction information, the main control unit 46B controls the motor drive control unit 50B according to the control instruction information so that the rotational speed of the second wheel motor 6B reaches the instantaneous target speed.

In the first motor unit 42A, when the wireless communication circuit 44A receives a new control command, the main control unit 46A creates a new control plan for the first wheel motor 6A and the second wheel motor 6B based on the current rotational speed of each motor, the target speed for each motor specified in the new control command, and the target achievement time specified in the new control command. The creation of the new control plan is implemented even when the current rotational speed of each motor has not reached the target speed specified in the immediately preceding control command.

Thereafter, the main control unit 46A controls the motor drive control unit 50A to adjust the rotational speed of the first wheel motor 6A according to the new control plan, and transmits the control instruction information on control of driving of the second wheel motor 6B to the second motor unit 42B by wired communication according to the new control plan. In this way, the rotational speeds of the wheel motors 6A, 6B are synchronized and adjusted repeatedly.

In the above example, the control cycle of each motor is 1 ms, but is not limited to 1 ms and may be 5 ms, for example.

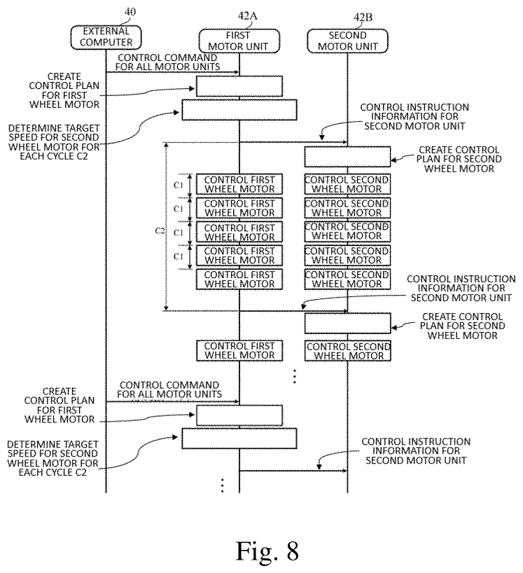

FIG. 8 is a sequence diagram showing another example of operation of controlling the plurality of motors in the control system according to the embodiment. The external computer 40, the first motor unit 42A, and the second motor unit 42B may operate according to the sequence diagram shown in FIG. 8.

As shown in FIG. 8, the external computer 40 transmits a control command for all the motor units 42A, 42B to the first motor unit 42A by wireless communication in the same manner as described above. In the first motor unit 42A, when the wireless communication circuit 44A receives the control command, the main control unit 46A stores the received control command in the memory 48A.

The main control unit 46A creates a control plan (first control plan) for the first wheel motor 6A. Specifically, the main control unit 46A determines an instantaneous target speed for the first wheel motor 6A for each moment until the target achievement time has elapsed. Each of the moments is separated from one another by a constant control cycle C1 (for example, 1 ms). The determination may be made by interpolation, for example linear interpolation, based on the current rotational speed of the motor 6A, the target speed for the motor 6A specified in the control command, and the target achievement time specified in the control command in the same manner as described above. Once determining the instantaneous target speed for the wheel motor 6A for each control cycle C1, the main control unit 46A stores the instantaneous target speed for the wheel motor 6A in the memory 48A.

Further, the main control unit 46A determines the instantaneous target speed for the second wheel motor 6B for each control cycle C2 (for example, 5 ms) that is longer than the control cycle C1, based on the control command. The determination may be made by interpolation, for example, linear interpolation, based on the current rotational speed of the motor 6B, the target speed for the motor 6B specified in the control command, and the target achievement time specified in the control command. Once determining the instantaneous target speed for the wheel motor 6B for each control cycle C2, the main control unit 46A stores the instantaneous target speed for the wheel motor 6B in the memory 48A.

Next, the main control unit 46A reads the instantaneous target speed for the second wheel motor 6B from the memory 48A, and transmits control instruction information indicating the instantaneous target speed for the second wheel motor 6B to the second motor unit 42B by wired communication. The main control unit 46A repeats, in the longer control cycle C2, reading out of the instantaneous target speed for the second wheel motor 6B and transmitting of the control instruction information to the second motor unit 42B by wired communication.

Upon receiving the control instruction information from the first motor unit 42A, the main control unit 46B of the second motor unit 42B creates a control plan (second control plan) for the second wheel motor 6B. Specifically, the main control unit 46B determines the instantaneous target speed for the second wheel motor 6B for each moment of each shorter control cycle C1. The determination may be made by interpolation, for example, linear interpolation, based on the current rotational speed of the motor 6B, the target speed of the motor 6B indicated by the control instruction information, and the length of the control cycle C2. Once determining the instantaneous target speed for the wheel motor 6B for each control cycle C1, the main control unit 46B stores the instantaneous target speed for the wheel motor 6B in the memory 48B.

Thereafter, the main control unit 46A controls the motor drive control unit 50A to adjust the rotational speed of the first wheel motor 6A according to the first control plan. That is, the main control unit 46A repeats, in the control cycle C2, reading of the instantaneous target speed for the first wheel motor 6A from the memory 48A at each moment, and controlling of the motor drive control unit 50A so that the rotational speed of the first wheel motor 6A reaches the instantaneous target speed.

Further, the main control unit 46B controls the motor drive control unit 50B to adjust the rotational speed of the second wheel motor 6B according to the second control plan. That is, the main control unit 46B repeats, in the control cycle C2, reading of the instantaneous target speed for the second wheel motor 6B from the memory 48B at each moment, and controlling of the motor drive control unit 50B so that the rotational speed of the second wheel motor 6B reaches the instantaneous target speed. In this way, the rotational speeds of the wheel motors 6A, 6B are synchronized and adjusted repeatedly. In this case, even when the control instruction information cannot be transmitted from the first motor unit 42A to the second motor unit 42B in the shorter control cycle C1, the rotational speed of the wheel motor 6B can be adjusted in the shorter control cycle C1.

In the first motor unit 42A, when the wireless communication circuit 44A receives a new control command, the main control unit 46A creates a new first control plan for the first wheel motor 6A, and determines an instantaneous target speed for the second wheel motor 6B in the longer control cycle C2. The creation of the new first control plan and determination of the instantaneous target speed for the wheel motor 6B are implemented even when the current rotational speed of each motor has not reached the target speed specified in the immediately preceding control command.

Thereafter, the main control unit 46A transmits control instruction information on control of driving of the second wheel motor 6B to the second motor unit 42B by wired communication, and controls the motor drive control unit 50A to adjust the rotational speed of the first wheel motor 6A according to the new first control plan. The main control unit 46B creates a new second control plan for the second wheel motor 6B, and controls the motor drive control unit 50B to adjust the rotational speed of the second wheel motor 6B according to the new second control plan.

As described above, the control command transmitted by wireless communication includes information indicating the target achievement time for driving the wheel motors 6A, 6B. The target achievement time may be constant at all times (for example, 100 ms). However, arrival time of a signal may vary depending on the propagation path in wireless communication. In view of this, it is preferable that the external computer 40 determines the target achievement time for driving the wheel motors 6A, 6B according to the wireless propagation delay between the external computer 40 and the wireless communication circuit 44A. Specifically, the longer the wireless propagation delay, the longer the target achievement time is determined. This makes it easy to synchronize the driving of the wheel motors 6A, 6B regardless of the wireless propagation delay. The wireless propagation delay can be estimated by measuring a round trip time between the external computer 40 and the wireless communication circuit 44A by a publicly known technique.

The transmission interval of the control command transmitted from the external computer 40 to the first motor unit 42A may be the same as the target achievement time for driving the wheel motors 6A, 6B. However, arrival time of a signal may vary depending on the propagation path in wireless communication. In view of this, the transmission interval of the control command is preferably shorter than the target achievement time. This can be applied whether the target achievement time is constant or variable. For example, the target achievement time can be set to 100 ms, and the transmission interval of the control command can be set to 80 ms. Even when the current rotational speed of each motor has not reached the target speed specified in the immediately preceding control command when a new control command is received, the moving body 1 can determine the instantaneous target speeds for the wheel motors 6A, 6B based on the current rotational speed and the target speed specified in the new control command. This makes it easy to synchronize the driving of the wheel motors 6A, 6B regardless of the wireless propagation delay.

In the present embodiment, the main control unit 46A of the first motor unit 42A receives a control command for the wheel motors 6A, 6B by wireless communication from the external computer 40, and transmits control instruction information on the wheel motor 6B to the main control unit 46B of the second motor unit 42B by wired communication, thereby facilitating synchronization of operation of the wheel motors 6A, 6B. Further, due to the solidity of wired communication, the control instruction information on the wheel motor 6B can be reliably and promptly transmitted to the main control unit 46B. In addition, the wired communication inside the moving body 1 leads to reduction in traffic of wireless communication with the external computer 40.

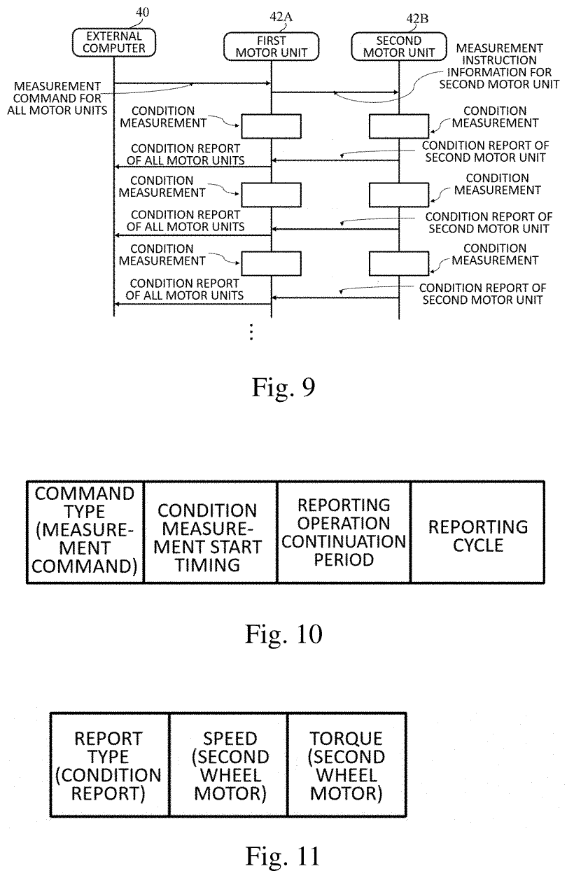

With reference to FIG. 9, the description will be given of an example of operation of measuring and reporting the condition of the motor units 42A, 42B performed by the motor units 42A, 42B. This operation is individually performed for each moving body 1 in the moving device 30 including a plurality of moving bodies 1 (see FIGS. 3 and 4).

As shown in FIG. 9, the external computer 40 transmits a measurement command for all the motor units 42A, 42B to the first motor unit 42A by wireless communication. The measurement command for all the motor units 42A, 42B is a command instructing to measure the current rotational speed and the current torque of the first wheel motor 6A of the first motor unit 42A, the current rotational speed and the current torque of the second wheel motor 6B of the second motor unit 42B, and the current rotation angle of the rotating base 20 and to report the measured results.

As shown in FIG. 10, a format of the measurement command includes, for example, a field indicating a command type, a field indicating a condition-measurement start timing, a field indicating a reporting operation continuation period, and a field indicating a reporting cycle (measurement cycle). The field indicating a command type includes a bit string indicating that the transmitted command is a measurement command.

In the first motor unit 42A, when the wireless communication circuit 44A receives the measurement command from the external computer 40, the main control unit 46A stores the measurement command in the memory 48A. Further, the main control unit 46A transmits measurement instruction information for the second motor unit 42B to the second motor unit 42B by wired communication. The measurement instruction information has the same format as the measurement command, and indicates the condition-measurement start timing, the reporting operation continuation period, and the reporting cycle specified in the measurement command. In the second motor unit 42B, when the main control unit 46B receives the measurement instruction information from the first motor unit 42A by wired communication, the main control unit 46B stores the measurement instruction information in the memory 48B.

The main control unit 46A performs a condition measurement operation at the condition-measurement start timing specified in the measurement command. Specifically, the main control unit 46A causes the motor drive control unit 50A to measure the rotational speed and the torque of the first wheel motor 6A, and receives the measured values of the rotational speed and the torque from the motor drive control unit 50A. Further, the main control unit 46A measures the rotation angle of the rotating base 20.

Further, the main control unit 46B performs the condition measurement operation at the condition-measurement start timing indicated by the measurement instruction information. Specifically, the main control unit 46B causes the motor drive control unit 50B to measure the rotational speed and the torque of the second wheel motor 6B, and receives the measured values of the rotational speed and the torque from the motor drive control unit 50B. After completion of the measurement operation, the main control unit 46B transmits a report indicating the measurement result to the first motor unit 42A by wired communication as a condition report of the second motor unit 42B. FIG. 11 shows an example of a format of the condition report of the second motor unit 42B. A field for a report type shown in FIG. 11 includes a bit string indicating that this report is a condition report of the second motor unit 42B.

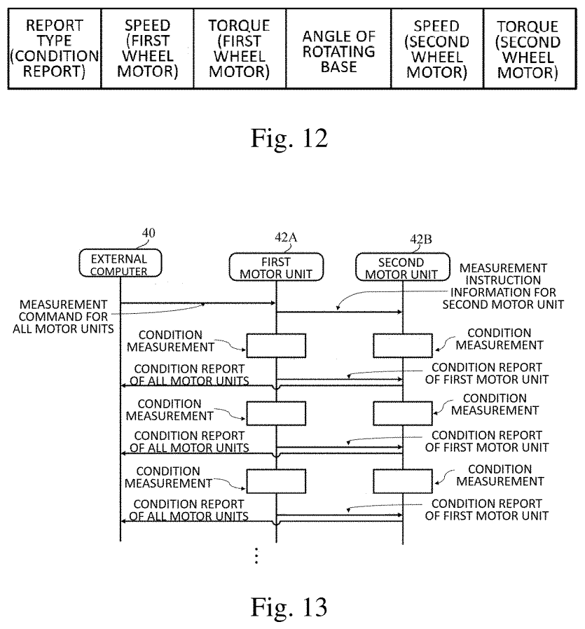

Upon receiving the condition report of the second motor unit 42B, the main control unit 46A of the first motor unit 42A collectively transmits the condition report on all the motor units 42A, 42B indicating the measurement result by the main control unit 46A and the measurement result by the main control unit 46B to the external computer 40 by wireless communication. That is, the main control unit 46A connects the measurement result by the main control unit 46A with the measurement result by the main control unit 46B to generate one condition report, and transmits the information report to the external computer 40. FIG. 12 shows an example of a format of the condition report of all the motor units 42A, 42B. A field for a report type shown in FIG. 12 includes a bit string indicating that this report is a condition report of all the motor units.

Thereafter, in the reporting cycle (measurement cycle) specified in the measurement command, the main control unit 46A of the first motor unit 42A performs the condition measurement operation, and the main control unit 46B of the second motor unit 42B performs the condition measurement operation. Then, the second motor unit 42B transmits the condition report of the second motor unit 42B to the first motor unit 42A by wired communication, and the first motor unit 42A collectively transmits the condition report of all the motor units 42A, 42B to the external computer 40 by wireless communication. Since one condition report transmitted by wireless communication includes the measurement result by the main control unit 46A and the measurement result by the main control unit 46B, traffic of wireless communication can be reduced as compared with the case where the measurement results are individually transmitted by wireless communication, thereby reducing the load for reception processing on the external computer 40.

Since the external computer 40 causes the measurement command to include the reporting cycle, a single transmission of the measurement command causes the moving body 1 to periodically perform the measurement and reporting operation. Therefore, traffic of wireless communication can be reduced as compared with the case where the command is transmitted periodically, thereby reducing the transmission processing load on the external computer 40.

The above described condition reporting operation is repeated until the reporting operation continuation period specified in the measurement command has elapsed. When the reporting operation continuation period has elapsed, the motor units 42A, 42B end the condition measurement operation and the transmission of the condition report. Since the external computer 40 causes the measurement command to include the reporting operation continuation period, the moving body 1 can end the measurement and reporting operation without transmission of a command to end the measurement. Therefore, traffic of wireless communication can be reduced as compared with the case where a command to end the measurement is transmitted, thereby reducing the transmission processing load on the external computer 40.

In the present operation example, the main control unit 46A of the first motor unit 42A receives the measurement command for the wheel motors 6A, 6B by wireless communication from the external computer 40, and transmits the measurement instruction information on the wheel motor 6B to the main control unit 46B of the second motor unit 42B by wired communication, thereby facilitating synchronization of the measurement on the wheel motors 6A, 6B. Further, due to the solidity of wired communication, the measurement instruction information on the wheel motor 6B can be reliably and promptly transmitted to the main control unit 46B. In addition, the wired communication inside the moving body 1 leads to reduction in traffic of wireless communication with the external computer 40. Furthermore, due to a reporting operation using wired communication inside the moving body 1 and a collective reporting operation from the main control unit 46A of the first motor unit 42A using wireless communication, traffic of wireless communication with the external computer 40 can be reduced, thereby reducing the reception processing load on the external computer 40.

In the present operation example, a plurality of items, that is, the rotational speed and the torque of the motors and the rotation angle of the rotating base 20, are measured and reported in response to one measurement command. Therefore, traffic of wireless communication can be reduced as compared with the case where the measurement command is transmitted for each item by wireless communication, thereby reducing the transmission processing load on the external computer 40.

FIG. 13 is a sequence diagram showing another example of operation of measuring and reporting the condition of the motor units 42A, 42B performed by the motor units 42A, 42B in the control system according to the embodiment. The external computer 40, the first motor unit 42A, and the second motor unit 42B may operate according to the sequence diagram shown in FIG. 13.

In the operation example of FIG. 13, the wireless communication circuit 44B of the second motor unit 42B is used. The wireless communication circuit 44A of the first motor unit 42A is used for reception from the external computer 40, and the wireless communication circuit 44B of the second motor unit 42B is used for transmission to the external computer 40.

In the present operation example, the main control unit 46B of the second motor unit 42B does not transmit a condition report to the first motor unit 42A, but the main control unit 46A of the first motor unit 42A transmits a condition report to the second motor unit 42B. Further, instead of the main control unit 46A of the first motor unit 42A, the main control unit 46B of the second motor unit 42B transmits a condition report of all the motor units to the external computer 40. The other features are the same as the operation example of FIG. 9.

That is, the external computer 40 transmits the measurement command for all the motor units 42A, 42B to the first motor unit 42A by wireless communication, and the main control unit 46A transmits the measurement instruction information for the second motor unit 42B to the second motor unit 42B by wired communication.

The main control unit 46A performs the condition measurement operation at the condition-measurement start timing specified in the measurement command transmitted from the external computer 40 by wireless communication. Specifically, the main control unit 46A causes the motor drive control unit 50A to measure the rotational speed and the torque of the first wheel motor 6A, and receives the measured values of the rotational speed and the torque from the motor drive control unit 50A. Further, the main control unit 46A measures the rotation angle of the rotating base 20.

After completion of the measurement, the main control unit 46A transmits a report indicating the measurement result to the second motor unit 42B by wired communication as a condition report of the first motor unit 42A. An example of a format of the condition report of the second motor unit 42B is similar to the one shown in FIG. 11. However, a field for a report type includes a bit string indicating that this report is a condition report of the first motor unit 42A. The condition report of the first motor unit 42A indicates the rotational speed and the torque of the first wheel motor 6A and the rotation angle of the rotating base 20.

Further, the main control unit 46B performs the condition measurement operation at the condition-measurement start timing indicated by the measurement instruction information. Specifically, the main control unit 46B causes the motor drive control unit 50B to measure the rotational speed and the torque of the second wheel motor 6B, and receives the measured values of the rotational speed and the torque from the motor drive control unit 50B.

Upon receiving the condition report of the first motor unit 42A, the main control unit 46B of the second motor unit 42B collectively transmits the condition report on all the motor units 42A, 42B indicating the measurement result by the main control unit 46A and the measurement result by the main control unit 46B to the external computer 40 by wireless communication. That is, the main control unit 46B connects the measurement result by the main control unit 46A with the measurement result by the main control unit 46B to generate one condition report, and transmits the information report to the external computer 40.

Thereafter, in the reporting cycle (measurement cycle) specified in the measurement command, the main control unit 46A of the first motor unit 42A performs the condition measurement operation, and the main control unit 46B of the second motor unit 42B performs the condition measurement operation. Then, the first motor unit 42A transmits the condition report of the first motor unit 42A to the second motor unit 42B by wired communication, and the second motor unit 42B collectively transmits the condition report of all the motor units 42A, 42B to the external computer 40 by wireless communication. Since one condition report transmitted by wireless communication includes the measurement result by the main control unit 46A and the measurement result by the main control unit 46B, traffic of wireless communication can be reduced as compared with the case where the measurement results are individually transmitted by wireless communication, thereby reducing the load for reception processing on the external computer 40.

Since the external computer 40 causes the measurement command to include the reporting cycle, a single transmission of the measurement command causes the moving body 1 to periodically perform the measurement and reporting operation. Therefore, traffic of wireless communication can be reduced as compared with the case where the command is transmitted periodically, thereby reducing the transmission processing load on the external computer 40.

The above described condition reporting operation is repeated until the reporting operation continuation period specified in the measurement command has elapsed. When the reporting operation continuation period has elapsed, the motor units 42A, 42B end the condition measurement operation and the transmission of the condition report. Since the external computer 40 causes the measurement command to include the reporting operation continuation period, the moving body 1 can end the measurement and reporting operation without transmission of a command to end the measurement. Therefore, traffic of wireless communication can be reduced as compared with the case where a command to end the measurement is transmitted, thereby reducing the transmission processing load on the external computer 40.

In the present operation example, the main control unit 46A of the first motor unit 42A receives the measurement command for the wheel motors 6A, 6B by wireless communication from the external computer 40, and transmits the measurement instruction information on the wheel motor 6B to the main control unit 46B of the second motor unit 42B by wired communication, thereby facilitating synchronization of the measurement on the wheel motors 6A, 6B. Further, due to the solidity of wired communication, the measurement instruction information on the wheel motor 6B can be reliably and promptly transmitted to the main control unit 46B. In addition, the wired communication inside the moving body 1 leads to reduction in traffic of wireless communication with the external computer 40. Furthermore, due to a reporting operation using wired communication inside the moving body 1 and a collective reporting operation from the main control unit 46B of the second motor unit 42B using wireless communication, traffic of wireless communication with the external computer 40 can be reduced, thereby reducing the reception processing load on the external computer 40.

In the present operation example, a plurality of items, that is, the rotational speed and the torque of the motors and the rotation angle of the rotating base 20, are measured and reported in response to one measurement command. Therefore, traffic of wireless communication can be reduced as compared with the case where the measurement command is transmitted for each item by wireless communication, thereby reducing the transmission processing load on the external computer 40.

Although the embodiments of the present disclosure have been described above, the above description should not limit the present disclosure, and various modifications including deletion, addition, and replacement of components can be considered to fall within the technical scope of the present disclosure.

For example, each moving body 1 includes two wheels 4A, 4B, and two wheel motors 6A, 6B according to the above embodiments. However, each moving body 1 may include three or more wheels, and three or more motor units for driving the three or more wheels. In this case, the main control unit of one of the motor units (first motor unit 42A) can receive a control command and a measurement command from the external computer 40 by wireless communication, and transmit control instruction information and measurement instruction information to the other motor units (a plurality of second motor units) by wired communication. Further, the plurality of second motor units can transmit their respective condition reports to one of the motor units (first motor unit 42A) that has received the measurement command from the external computer 40, and the first motor unit 42A can collectively transmit the condition report of all the motor units to the external computer 40 by wireless communication. Alternatively, the plurality of motor units including the first motor unit 42A can transmit their respective condition reports to one of the motor units other than the first motor unit 42A (second motor unit 42B), and the second motor unit 42B can collectively transmit the condition reports of all the motor units to the external computer 40 by wireless communication.

The rotation angle of the rotating base 20 is measured by the main control unit 46A of the first motor unit 42A according to the above embodiments, but may be measured by the main control unit 46B of the second motor unit 42B.

The speed and the torque of the motors and the rotation angle of the rotating base 20 are measured and reported according to the above embodiments. However, other conditions may be measured and reported. For example, the moving body 1 may measure its own position or the position of each wheel, and report the measured result to the external computer 40. For example, the moving body 1 can measure its own position or the position of each wheel by a navigation satellite system, a Wi-Fi positioning system, a base station positioning system, a camera image positioning system, or a combination thereof.

An example of the automatic device is the moving body 1 according to the above embodiments, but the automatic device may be a robot, such as a manufacturing robot or a service robot, or may be a transfer apparatus, such as a belt conveyor or a roller conveyor.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. An automatic device comprising:
a support;
a first motor attached to the support;
a second motor attached to the support;
a first motor drive unit configured to drive the first motor;
a second motor drive unit configured to drive the second motor;
a first control unit configured to control the first motor drive unit; and
a second control unit configured to control the second motor drive unit,
wherein the first control unit includes a first wireless communication circuit for wireless communication with an external control device, and
wherein the first control unit and the second control unit are communicably wired with each other.

2. The automatic device according to claim 1,
wherein the first control unit
receives a command regarding the first motor and the second motor from the external control device by wireless communication,
performs operation regarding the first motor according to the command, and
transmits instruction information on the second motor based on the command to the second control unit by wired communication, and
wherein the second control unit
receives the instruction information on the second motor from the first control unit by wired communication, and
performs operation regarding the second motor according to the instruction information on the second motor.

3. The automatic device according to claim 2,
wherein the first control unit
receives a control command for controlling driving of the first motor and driving of the second motor from the external control device by wireless communication,
creates a control plan for controlling driving of the first motor and driving of the second motor based on the control command,
controls the first motor drive unit according to the control plan, and
transmits control instruction information on control of driving of the second motor to the second control unit by wired communication according to the control plan, and
wherein the second control unit
receives the control instruction information on control of driving of the second motor from the first control unit by wired communication, and
controls the second motor drive unit according to the control instruction information on control of driving of the second motor.

4. The automatic device according to claim 2,
wherein the first control unit
receives a control command for controlling driving of the first motor and driving of the second motor from the external control device by wireless communication,
creates a first control plan for controlling driving of the first motor based on the control command,
determines a control target value for controlling driving of the second motor based on the control command,
controls the first motor drive unit in a first cycle according to the first control plan, and
transmits control instruction information indicating the control target value to the second control unit by wired communication in a second cycle that is longer than the first cycle, and
wherein the second control unit
receives the control instruction information from the first control unit by wired communication,
creates a second control plan for controlling driving of the second motor based on the control target value indicated in the control instruction information, and
controls the second motor drive unit in the first cycle according to the second control plan.

5. The automatic device according to claim 2,
wherein the first control unit
receives a measurement command regarding measurement of condition of the first motor and the second motor from the external control device by wireless communication,
measures the condition of the first motor according to the measurement command, and
transmits measurement instruction information on the second motor to the second control unit by wired communication, and
wherein the second control unit
receives the measurement instruction information on the second motor from the first control unit by wired communication, and
measures the condition of the second motor according to the measurement instruction information on the second motor.

6. The automatic device according to claim 5,
wherein the second control unit reports the condition of the second motor measured by the second control unit to the first control unit by wired communication, and
wherein the first control unit reports the condition of the second motor reported from the second control unit and the condition of the first motor measured by the first control unit to the external control device by wireless communication.

7. The automatic device according to claim 6,
wherein the second control unit periodically measures the condition of the second motor, and periodically reports the condition of the second motor measured by the second control unit to the first control unit by wired communication, and
wherein the first control unit periodically measures the condition of the first motor, and periodically reports the condition of the second motor reported from the second control unit and the condition of the first motor measured by the first control unit to the external control device by wireless communication.

8. The automatic device according to claim 1,
wherein the second control unit includes a second wireless communication circuit configured to wirelessly communicate with the external control device.

9. The automatic device according to claim 5,
wherein the second control unit includes a second wireless communication circuit configured to wirelessly communicate with the external control device,
wherein the first control unit reports the condition of the first motor measured by the first control unit to the second control unit by wired communication, and
wherein the second control unit reports the condition of the first motor reported from the first control unit and the condition of the second motor measured by the second control unit to the external control device by wireless communication.

10. The automatic device according to claim 9,
wherein the first control unit periodically measures the condition of the first motor, and periodically reports the condition of the first motor measured by the first control unit to the second control unit by wired communication, and
wherein the second control unit periodically measures the condition of the second motor, and periodically reports the condition of the first motor reported from the first control unit and the condition of the second motor measured by the second control unit to the external control device by wireless communication.

11. The automatic device according to claim 1,
wherein the support is a vehicle body, and the first motor and the second motor respectively rotate two wheels attached to the support.

12. A communication system comprising:
the automatic device according to claim 1; and
the external control device.

13. A communication system comprising:
the automatic device according to claim 3, and
the external control device,
wherein the external control device determines a target achievement time for driving the first motor and the second motor according to wireless propagation delay between the external control device and the first wireless communication circuit so that the target achievement time becomes longer as the wireless propagation delay increases, and causes the control command to include information indicating the target achievement time.

14. A communication system comprising:
the automatic device according to claim 3; and
the external control device,
wherein the external control device causes the control command to include information indicating target achievement time for driving the first motor and the second motor, and repeatedly transmits the control command at intervals each of which is shorter than the target achievement time.

15. A communication system comprising:
the automatic device according to claim 5; and
the external control device,
wherein the external control device causes the measurement command to include a cycle of measuring condition of each of the first motor and the second motor.
